(19) United States
(12) Patent Application Publication
(10) Pub. No.: US 2010/0038100 A1
(43) Pub. Date: Feb. 18, 2010

(54) FLUID SUPPLY UNIT

(76) Inventor: Lorne Schuetzle, Dunmore (CA)

Correspondence Address: BENNETT JONES LLP;C/O MS ROSEANN CALDWELL, 4500 BANKERS HALL EAST, 855 - 2ND STREET, SW, CALGARY, AB, T2P 4K7, CA

(21) Appl. No.: 12/441,697

(22) PCT Filed: Sep. 18, 2007
(86) PCT No.: PCT/CA2007/001649

§ 371 Date: Jun. 24, 2009

Related U.S. Application Data
(60) Provisional application No. 60/826,059, filed on Sep. 18, 2006.

(51) Int. Cl. A62C 27/00; E03B 5/00

(52) U.S. Cl. 169/52; 137/565.01

(57) ABSTRACT

A fully moveable and totally contained fluid supply unit useful in supplying fluid such as water to a site in need of such fluid for drilling, fire control, clean up, and the like is provided comprising a skid or a trailer having mounted thereon a fluid reservoir for holding the fluid; a fluid pumping system for pumping fluids to said site; and an engine for providing prime power to operate the fluid pumping system.

The present invention relates generally to an apparatus useful in supplying fluid such as water to a site in need of such fluid and, more particularly, the invention relates to a fully moveable, totally contained fluid supply unit that can carry sufficient fluid to meet many of the fluid requirements, for example, to a drilling rig, for killing a well during well kick, for controlling fires, for rig clean up, for dust control, for filling a drilling rig's water storage tank, and the like.

### BACKGROUND OF THE INVENTION

Conventionally, fluids such as water for well control and water for fire control are supplied by separate service companies in separate units, which are operated by separate operators. Fire control units used in the oil patch today do not carry the necessary amounts of water for both fire and well control. Typically, each fire-fighting unit is manned by two trained firefighters and carries a certified fire pump and an “Alcohol Type Concentrate” foam supply. Foam can be made either through a pump with the aid of the on board water supply, or by a nitrogen propelled premix system. The nitrogen also propels the “Purple K” Dry Chemical system that is equipped on each unit. This is ideal for quick knock down of a fire, especially in a gas rich environment.

The shower unit area of these trucks feature overhead and mid-section showers and eyewash stations, all supplied by heated, potable water. These units also have recovery bunks, first aid kits, and self-contained breathing apparatus. These units would typically be sent out to a hydraulic fracturing or “frac” job where a worker may come in contact with a dangerous chemical that is being used in the fracturing process. The unit would also be used for standby capacity in case of equipment or a grass fire.

The problem with today's fire fighting units is that they don't carry the required amounts of water to suppress a gas kick at the wellhead if one occurs. They are designed as a mobile shower unit and first aid station. They carry a limited amount of dry chemical capably of knocking down only small flash fires. Thus, water used as kill fluid or kill-weight fluid for suppressing a well if a kick occurs would need to be supplied separately.

Kick refers to a flow of reservoir fluids into the wellbore during drilling operations. The kick is physically caused by the pressure in the wellbore being less than that of the formation fluids, thus causing flow. This condition of lower wellbore pressure than the formation can be caused if the drilling mud weight is too low, often called an underbalanced kick, or if dynamic and transient fluid pressure effects, usually due to motion of the drill string or casing, effectively lower the pressure in the wellbore below that of the formation, referred to as an induced kick.

In order to prevent a blowout from occurring during a kick situation, the well is preferably “killed”. To kill a well refers to stopping a well from flowing or having the ability to flow into the wellbore. Kill procedures typically involve circulating reservoir fluids out of the wellbore or pumping higher density mud, or kill-weight fluid, into the wellbore, or both. By pumping kill-weight fluid down the wellbore, the pressure exerted by the column of fluid (hydrostatic pressure) can be controlled. A well can be considered to be “killed” when sufficient fluid has been added to replace any formation fluid and create hydrostatic pressure equal to or slightly greater than the formation pressure.

Traditionally, a separate water truck or water bulker assembly has to supply the water that is to be used as kill fluid. These assemblies, however, are not equipped for fire fighting. Thus, the prior art has not recognized that a single trailer or skid unit can be provided with all the necessary equipment and accessories to supply a drilling rig with substantially all its water supply needs. Because of the duplicity of the prior art, this has caused a doubling of the transportation costs, a doubling of the personnel required to have the units arrive at the well site, and a doubling of the number of personnel required to run the services.

Furthermore, when drilling with mud, a separate water truck is used to deliver water to the rig tank to supply the water used for drilling with drilling mud. Generally, the rig tank is situated under the control room or “Dog House” on the drilling rig. The rig tank is generally quite large and can hold up to two or three loads of water. The drilling rig uses the water to wash and clean drilling components, buildings and the like during drilling. The water supplied to the rig tank can be used to mix drilling mud for mud drilling, which is then pumped by a mud pump (Triplex Pump) down hole. The rig tank water can also be used for mixing kill fluids.

A water truck must be present at all times (24 hours a day) to replenish the rig tank during conventional drilling using mud. Furthermore, the water must be off loaded from the drilling rig before the drilling rig can be moved to the next location.

### SUMMARY OF THE INVENTION

In accordance with one broad aspect of the invention, there is provided a totally contained moveable fluid supply unit, said unit having:
a skid or a trailer having mounted thereon:
a fluid reservoir for holding fluid;
a fluid pumping system for pumping fluids; and
an engine for providing prime power to operate the fluid pumping system.

In one embodiment, the fluid supply unit further has mounted on the skid or the trailer a dry chemical compartment for holding dry chemicals, which dry chemicals can be used separately for controlling smaller fires or in combination with the fluid. In a further embodiment, the fluid supply unit further has mounted on the skid or the trailer a foam tank for supplying foam as a further fire retardant.

In another embodiment, the engine is housed in a separate compartment, referred to as the control room, which is also mounted on the skid or the trailer. The engine is preferably a diesel engine and the moveable fluid supply unit further has a diesel tank for providing diesel fuel to the engine for operating the fluid pumping system.

The fluid pumping system may have a swivelable fire-fighting turret comprising a curved pipe and a nozzle, which turret can be directed towards a fire by means of a servo joystick. Further, the fluid pumping system may have at least one fire-fighting hose for manually controlling fires. The servo joystick is generally housed in a control room, which control room can be a separate compartment or may be combined with the engine room. Preferably, the fire-fighting turret is mounted on the roof of the control/engine room.

In another embodiment, the fluid supply unit of the present invention further has at least one steam line which is plumbed through the fluid reservoir to stop the fluid reservoir from freezing during cooler weather. For example, 2″ steel lines may be used to completely line the inside walls of the fluid reservoir. Preferably, the at least one steam line is also plumbed through the foam tank. The steam line can also be used for a heater to heat the control room and the engine room.

Most drilling rigs are provided with a diesel-fired scotch boiler, which is designed to create large amounts heated steam for use in various process or heating applications. Flexible steam lines or steam hoses connect the fluid supply unit of the present invention to the steam supply.

The trailer itself can have at least one stabilizer for stabilizing the trailer when it is parked on uneven ground. In a preferred embodiment, the stabilizers are powered by a hydraulic pump mounted on the engine housed in the engine room and are controlled by hydraulic valves located in two places, one in the front of the trailer and the other in the control room. The stabilizers may be metal legs that can move in two directions, horizontally and vertically, to increase the stability of the load. These metal legs may have large pads attached to the bottom; these pads increase the footprint on the ground to decrease soil compression and impaction. When the moveable fluid supply unit comprises a skid, the skid can be mounted on a suitable trailer for transport.

The fluid supply unit of the present invention may be easily adapted to be used in conjunction with reverse circulation drilling using concentric drill string, in particular where compressed air is used to drive an air hammer and drill bit. The compressed air is supplied to the drilling rig by large air compressors onsite. Thus, these compressors may also be utilized to supply the moveable unit of the present invention with compressed air to increase the performance of the fire fighting foam. Using compressed air in the foaming system reduces the size of the soap bubbles in the water stream to improve the capacity of the foam to adhere to the surface being protected.

In addition, when drilling with concentric drill string using reverse circulation, the drilling rig can clean out kill fluid from the well bore by blowing compressed air down the annulus between the inner pipe or tube and the outer pipe or tube. The water is pushed out of the hole by compressed air, recycled through hoses attached to the kill line on the surface blow out preventers (BOPs) and attached to the fluid reservoir on the moveable fluid supply unit of the present invention.

In a preferred embodiment, the present fluid supply unit has been designed to carry at least about 40 m³ or 40,000 liters of fluid such as water, which quantity will satisfy the EUB requirement of having twice the kill fluid on hand that is required to fill the well bore if a kick occurs. This amount is more than adequate for drilling rigs that drill shallow gas wells, i.e., a well up to 1200 meter deep. Hence, the fluid supply unit can supply the rig with the fluid it may require while it is drilling, for dust control and rig cleanup, grass fires, dust control on roads alongside farmer farms, and filling a tank for mixing of special blends of kill-weight fluid. The fluid supply unit of the present invention is fully moveable so that the extra fluid can be transported to the next location, thereby reducing costs.

In a preferred embodiment, the unit can carry about 400 hundred gallons or more of Class B and C fire fighting foam concentrate and this foam can be applied at 3% or 6% or 9% ratio depending on the type of fire that has occurred. Pumped thought a 1500 gpm centrifugal water pump to produce 250 psi of pressure, and adding compressed air from the Rig's compressors to multiply the fire fighting capabilities of the water foam mixture. The fluid supply unit can project fire fighting agent though it's roof mounted turret over 200 feet away.

The fluid supply unit of the present invention may have one or more of the following beneficial properties: reduction in water hauling costs; increased fire fighting capabilities; reduction in the number of service companies required, thereby reducing the cost of drilling using the reverse circulation method; increased safety onsite by including a gas detection system at the BOPs and the flare stack; and reduced transportation costs as it is fully moveable and mounted on a standard tractor trailer unit.

Finally, the fluid supply unit can be used to fill rig tanks on drilling rigs by pumping water from its fluid reservoir thought the centrifugal pump thought the water manifold thought a value outlet and to the rig tank through 4-inch hoses also called kill fluid hoses. The fluid supply unit can reload this water by sucking it out of the rig tank thought the cleanout value on the rig tank using the same hoses that were used to fill it.

In another embodiment there is provided a contained moveable fluid supply unit having:
a skid or a trailer having mounted thereon:
a fluid reservoir for holding fluid;
a dry chemical compartment for housing a dry chemical tank; and
a control room for housing a fluid pumping system for pumping the fluid from the fluid reservoir to a site in need of such fluid.

In one embodiment, the dry chemical compartment further houses a foam tank.

It is understood that not only can the fluid supply unit of the present invention work along side any drilling rig, the unit can also perform fire watch at oil refineries or Gas Plants. It can provide coverage anywhere the foam must be projected several stories high. For example, it can provide foam displacement on runways at airports or fire fighting capabilities at forest fire, essentially anywhere a fire truck is needed.

### BRIEF DESCRIPTION OF THE DRAWINGS

FIG. 1 is a schematic showing the front end of one embodiment of a fluid supply unit of the present invention.

FIG. 2 is a schematic showing the back end of one embodiment of a fluid supply unit of the present invention.

FIGS. 3a and 3b are rear views of a fluid supply unit of the present invention where the stabilizers are, respectively, in a raised position when transporting the unit and in a lowered position to stabilize the unit at site.

FIG. 4 is a perspective of another embodiment of a fluid supply unit of the present invention.

### DESCRIPTION OF THE PREFERRED EMBODIMENTS

The invention is exemplified by the following embodiments. It is understood that like numbers represent like elements.

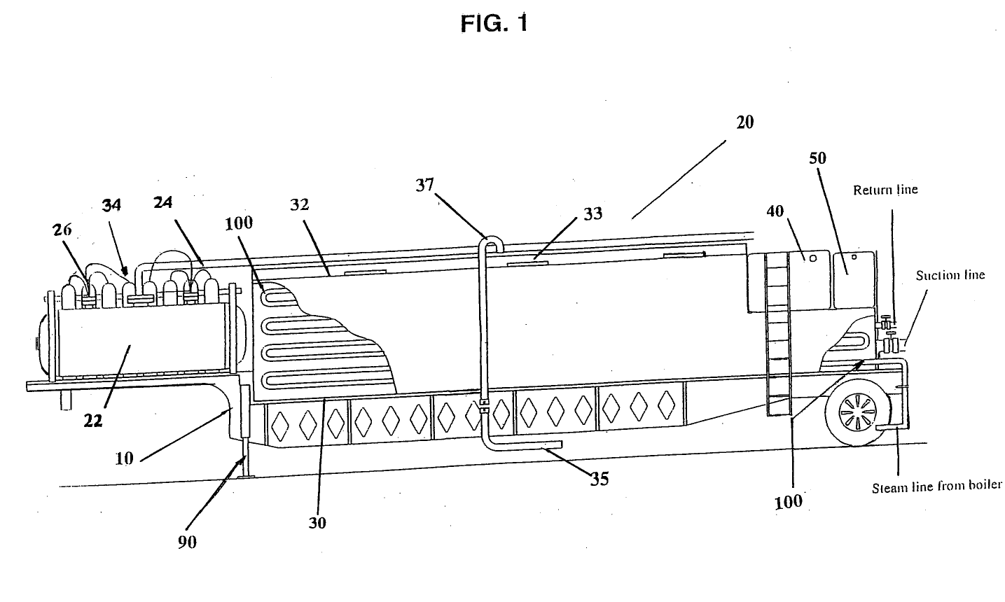

An embodiment of the present invention will be described with reference to FIGS. 1 to 3. With reference first to FIG. 1, which illustrates the front end of one embodiment of the fluid supply unit of the present invention, fluid supply unit 20 comprises a standard 53-foot or 48-foot drop deck base trailer 10, which trailer has a 65,000-pound carrying capacity. Trailer 10 comprises trailer bed 30 and mounted on trailer bed 30 are the following elements, configured so as to easily fit on trailer bed 30. Fluid reservoir or water tank 32 is preferably a rectangular shape to meet the Department of Transport regulations. Preferably, fluid reservoir 32 has a 40,000 liters or 40 m³ capacity for fluid storage. It can be made of any number of different materials, for example, steel, aluminum or molded plastic. Water tank 32 preferably has one or more tank hatches 33.

Situated adjacent to fluid reservoir 32 is dry chemical compartment 34 comprising dry chemical tank 22, which preferably can carry up to 3000 pounds or more of dry chemicals such Purple-K dry chemical 24, which is the most effective dry chemical for fighting class B fires. Purple-K is a potassium bicarbonate based dry chemical containing chemical additives, and is produced by an exclusive chemical process. Other Class C fire fighting dry chemical known in the art may be used. The unit of the present invention can also be equipped with nitrogen tanks 26.

Foam tank 50 is situated on top of fluid reservoir 32, and preferably has a 1500-liter capacity. Foam that can be used in the present invention includes Aircraft Fire Fighting Foam (AFFF) or any other liquid foam concentrate known in the art. Foam is useful for smothering fires by prevent air from reaching the flammable materials and lowering the heat of the combustion by a cooling action.

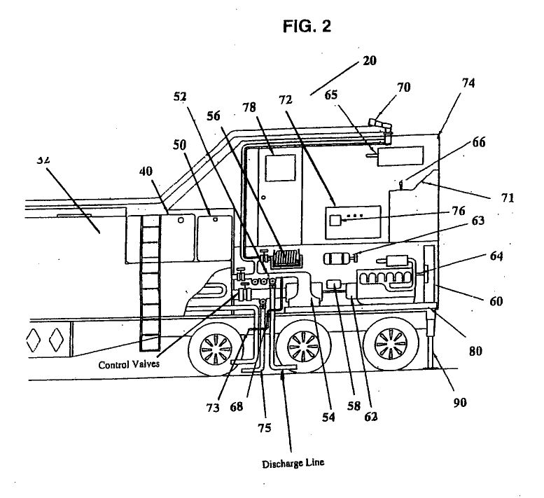

The foam tank 50 contains the liquid foam concentrate held separately from the water. This allows the water to be used in other capacities, such as dust control and kill fluid. With reference to FIG. 2, which illustrates the back end of the one embodiment of the fluid supply unit 20 of the present invention shown in FIG. 1, the foam concentrate from foam tank 50 is delivered to water manifold 52 and mixes with the water delivered from fluid reservoir 32. The foam solution then discharges through hand-held hoses 56 or fire fighting foam turret 70, as described in more detail below. The ratio of foam concentrate to water is electronically regulated at the injection point. The controls for this system are mounted in the control panels 71 and 72 housed in the control room 74 which comprises control room door 78. Control panel 72 further comprises gas detection control panel 76.

The fluid supply unit 20 further comprises a fluid pumping system for pumping fluids, which is housed in engine room 60, as illustrated in FIG. 2. The fluid pumping system comprises water pump 58 and planetary drive 62. Further housed in engine room 60 is a 300-horse power diesel engine 64 preferably mounted on engine skid 80 for operating the water pump 58. Fuel tank 40, which preferably has a capacity of about 1800 liters, houses the fuel for the diesel engine 64 that drives the water pump 58. In a preferred embodiment, the engine room 60 is also equipped with a mid ship manifold 52 for loading and unload from both sides.

In the embodiment shown in FIG. 2, the engine room 60 is contiguous with control room 74, which further houses the necessary controls to maneuver the fire-fighting turret 70 to aim at the fire. It is understood, however, that the fluid supply unit could comprise separate power and control rooms.

The directional movement of turret 70 may be achieved by using a servo control joystick 66, which would be housed in the engine/control room 60. Turret 70 will automatically position itself to correspond with the position of the pointer on the servo control joystick to within a few degrees and maintain that position until the servo control joystick is moved again. The servo control joystick 66 could also have a manual override.

As previously mentioned, the engine room 60 is equipped with at least one dual standard fire fighting hose 56, which hose is preferably 150 feet or more in length. In a preferred embodiment, two hoses are provided, one hose 1½″ in diameter and the second hose 1″ in diameter. Both sides of the unit may have a hose reel for accommodating the fire hoses. The fire hoses are primarily used for manually fighting the fire by hand, using foam and/or dry chemical. Thus, hose 56 is only used for fighting small fires. Larger 4-inch hammer union fitting lines (not shown) are used for filling the wellbore, which lines are engineered to stay connected under high pressure and handle larger volumes of fluid. The engine room 60 can further comprise an electric power generator 63 for supplying power to the unit.

The controller equipment installed inside the control room, for example, gas detector control panel 76, will control methane monitors stationed at the flare stack and the BOPs, which are connected thought cables running back to the fluid supply unit.

Remote alarms and light relays stationed at the engineer's trailer and on the outside of the fluid supply unit will alert rig hands, services staff and managers to any potential hazard that may arise. The alarms are wirelessly controlled or cables connecting them back to the fluid supply unit.

For example, BW Technologies by Honeywell manufactures suitable gas detectors for the present invention. The solar-capable gas detector is completely modular in design, wireless multi-point system continuously monitors for toxic gases, combustibles and oxygen hazards. The self-contained, intrinsically safe controller is equipped with built-in alarms for instant notification. Independent power, wireless signal transmission and plug-in ports for all field interfaces, including remote sensors, remote alarms and relays.

The detector can activate remote relays and a solenoid driver to control emergency shutdown devices (ESD), building ventilation systems and other field interfaces. The remote relays could be configured to start the engine on the fluid supply unit any time methane gas is detected at ether two monitored locations. This would reduce response time and increases fire-fighting capabilities.

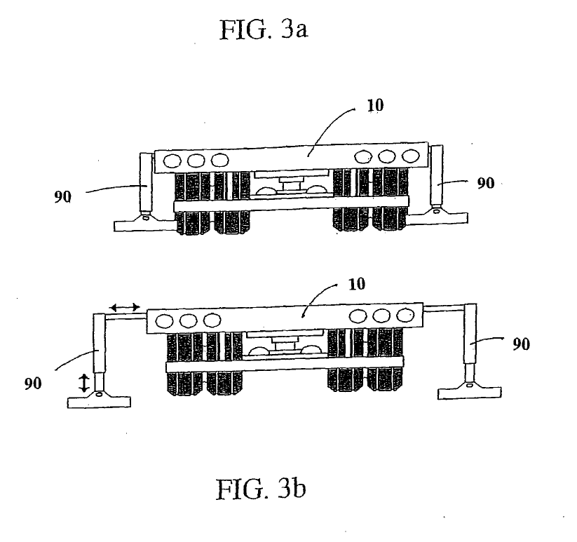

The trailer 10 can be equipped with standard stabilizers 90 as shown in FIGS. 1 and 2, to stabilizers the fluid supply unit when it is parked on uneven ground. They are hydraulically activated from the control room. The front stabilizer may be operated by an orbital motor for faster up and down movement for more efficient hookup by a semi-tractor. The stabilizers can be seen in more detail in FIGS. 3a and 3b.

Steam line 100 may be plumbed thought the water tank for cool weather operation to stop the tank for freezing as shown in FIG. 1. Steam line 100 may also be plumbed through the foam tank 50 and fuel tank 40. Steam line 100 can also be used to supply heat to the control room and engine room. Steam is generated using steam heater 65.

The fluid supply unit is particularly well suited for use in reverse circulation drilling, in particular, when air is used for drilling. A one-inch air hose from the drilling rig air supply (not shown) may then be attached to the side of the fluid supply unit using a standard high-pressure compressed air connection 68. The supplied air is piped via compressed air line 73 into the water manifold 52, which helps in pushing the water foam mixture out the fire turret 70 at a 1:1 ratio and further energizes the water-foam mixture, thereby breaking down the size of the foam bubbles and creating a smaller foam bubble which better adheres to any surface it coming in contact with.

To regulate the required air to water ratio, an in-line orifice controls the air volume added and a pressure regulator controls the air pressure prior to the air entering the water manifold 52. The air is piped into the discharge side of the water manifold 52 just in front of the turret 70. The flow is controlled by a ball valve to stop and supply the compressed air to the turret. The preferred formula to maintain the optimal performance of the fire fighting foam is 1 cubic foot per meter (cfm) of air must equal 1 pound per square inch (psi) of water pressure.

In one embodiment, if gas is detected at surface or at the flare stack, which may lead to an unsafe environment, the unit is equipped with 3000 pounds of dry chemical housed in dry chemical tank 22 which gives 1:30 minutes to 2:00 minutes of continuous dry chemical application. This is twice the capacity of any conventional fire fighting trucks that are used in the oil patch today.

Water trucks haul water to the unit and fill the fluid reservoir/water tank 32 by means of water fill hose 35 and water lead line 37 or the unit can draw water from a location that holds water, for example, by sucking water from a pond, ditch, lake, dugout, or loading from a water tower using suction lines 75. The unit can draw water by means of a diesel engine coupled directly to a centrifugal water pump 54. When the curved blades start rotating the pump creating suction on the intake side of the pump, this suction draws fluid into the pump. Once passing thought the pump, the blades push the fluid to the discharge side. This side of the pump builds fluid pressure, which diverted thought a manifold piping system can direct the water where needed.

Fluid supply unit 20 can be hooked up to any common tandem or tri drive 18-wheeler or a tractor-trailer unit can hock up to the deck of the trailer 10, and transport the unit from location to location.

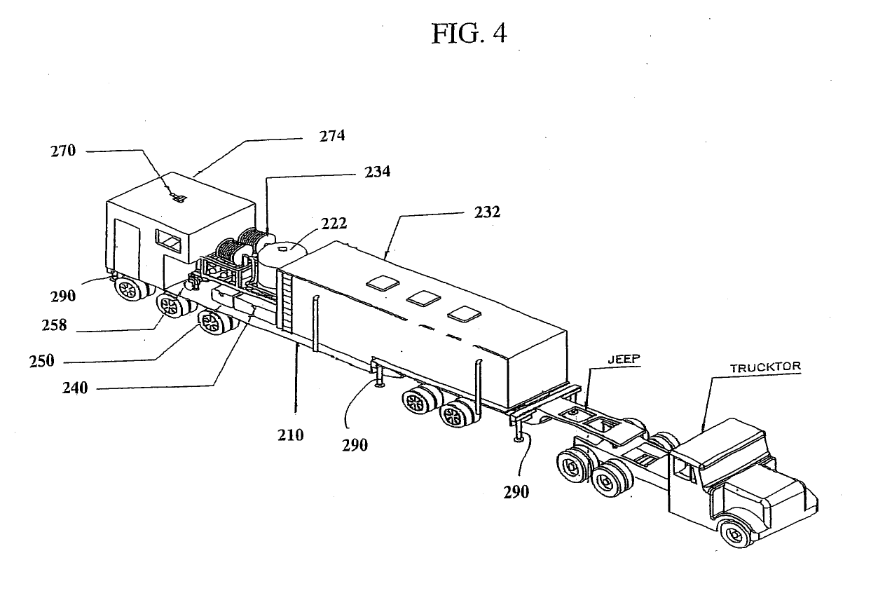

FIG. 4 illustrates another embodiment of the present invention showing a preferred configuration for weight distribution on a ten wheel trailer. In this embodiment, control room/engine room 274 having turret 270 on top is situated at the rear of trailer 210. Adjacent to the control room/engine room 274 is the dry chemical compartment 234 comprising dry chemical tank 222, foam tank 250, water pump 258 and diesel fuel tank 240. Adjacent the dry chemical compartment is fluid reservoir water tank 232. By way of example, the control room/engine room 274, comprising, among other equipment, a diesel engine and water pump, would preferably weigh about 3,000 Kg. The dry chemical compartment 234, comprising, among other equipment, a dry chemical tank, a foam tank and a diesel tank, would preferably weigh about 6,000 Kg.

Finally, fluid reservoir/water tank 232, when filled with fluid/water, would preferably weigh about 35,000 Kg.

1. A contained moveable fluid supply unit, comprising:
a skid or a trailer having mounted thereon:
a fluid reservoir for holding fluid;
a fluid pumping system for pumping fluids; and
an engine for providing prime power to operate the fluid pumping system.

2. The fluid supply unit as claimed in claim 1 further comprising:
a dry chemical compartment mounted on the skid or the trailer for holding dry chemicals.

3. The fluid supply unit as claimed in claim 1 further comprising:
a foam tank for supplying foam as a further fire retardant mounted on the skid or the trailer.

4. The fluid supply unit as claimed in claim 1 further comprising:
a control room mounted on the skid or the trailer for housing the fluid pumping system and engine.

5. The fluid supply unit as claimed in claim 1, wherein the engine is a diesel engine, further comprising:
a diesel tank for providing diesel fuel to the engine mounted on the skid or the trailer.

6. The fluid supply unit as claimed in claim 1, wherein the fluid pumping system further comprises a swivelable fire-fighting turret.

7. The fluid supply unit as claimed in claim 1, wherein the fluid pumping system further comprises at least one fire-fighting hose for manually controlling fires

8. The fluid supply unit as claimed in claim 1 further comprising:
at least one steam line that is plumbed through the fluid reservoir.

9. The fluid supply unit as claimed in claim 1, wherein the trailer comprises at least one stabilizer for stabilizing the trailer when it is stopped.

10. A contained moveable fluid supply unit comprising:
a skid or a trailer having mounted thereon:
a fluid reservoir for holding fluid;
a dry chemical compartment for housing a dry chemical tank; and
a control room for housing a fluid pumping system for pumping the fluid from the fluid reservoir to a site in need of such fluid.

11. A contained moveable fluid supply unit as claimed in claim 10, wherein the dry chemical compartment further houses a foam tank.
